(19) United States
(12) Patent Application Publication
(10) Pub. No.: US 2019/0266296 A1
(43) Pub. Date: Aug. 29, 2019

(54) MACHINING SIMULATION DEVICE OF MACHINE TOOL

(71) Applicant: FANUC CORPORATION, Yamanashi (JP)

(72) Inventors: Nobuaki AIZAWA, Yamanashi (JP); Hiroyuki FUJIMOTO, Yamanashi (JP)

(21) Appl. No.: 16/250,238

(22) Filed: Jan. 17, 2019

(30) Foreign Application Priority Data
Feb. 28, 2018 (JP) 2018-035947

(51) Int. Cl. G06F 17/50; G05B 19/4097

(52) U.S. Cl. CPC G06F 17/5009; G05B 2219/32301; G05B 19/4097

(57) ABSTRACT

A machining simulation device is a machining simulation device which performs a machining simulation of the machine tool that machines a machining target based on a machining program with a tool, and includes: a machine simulation unit which performs, based on a position command and a transfer characteristic of the machine tool, a simulation of the movement of the machine tool when the machine tool is operated based on the machining program so as to estimate the position of the tool; and a machining simulation unit which performs a machining simulation of the machining target based on information of the tool and the position of the tool that is estimated.

This application is based on and claims the benefit of priority from Japanese Patent Application No. 2018-035947, filed on 28 February, 2018, the content of which is incorporated herein by reference.

### BACKGROUND OF THE INVENTION

### Field of the Invention

The present invention relates to a machining simulation device of a machine tool.

### Related Art

There is a technology in which in a machine tool, before actual machining is performed, tool information (for example, information on the type of tool such as a ball end mill and a tool shape such as a tool diameter and a tool length) is used such that a machining simulation based on a machining program is performed. Patent document 1 discloses such a technology for a machining simulation.

However, in actual machining, machining cannot often be performed according to a machining program, and with a machining simulation based on a machining program, it is difficult to accurately evaluate, for example, the accuracy of a machined surface or the quality of a machined surface. In this regard, patent document 1 discloses a technology in which tool movement path data extracted from the sensing data of a control axis motor end or a machine end in an NC machine tool, that is, an actual position (feedback) detected with an actual sensor is further used such that a machining simulation is performed. In this way, it is considered that it is possible to accurately evaluate the accuracy of a machined surface, the quality of a machined surface or the like.
Patent Document 1: Japanese Patent No. 5610883

### SUMMARY OF THE INVENTION

However, when as the technology disclosed in patent document 1, the actual position (feedback) detected with the actual sensor is used such that the machining simulation is performed, each time the machining simulation is performed, a machine tool needs to be actually operated, with the result that it takes time to do so.

Hence, an object of the present invention is to provide a machining simulation device of a machine tool which can highly accurately perform a machining simulation while reducing an increase in time.

(1) A machining simulation device (for example, a machining simulation device 30 which will be described later) of a machine tool according to the present invention is a machining simulation device which performs a machining simulation of the machine tool (for example, a machine tool 5 which will be described later) that machines a machining target based on a machining program with a tool, and includes: a machine simulation unit (for example, a machine simulation unit 20 which will be described later) which performs, based on a position command and a transfer characteristic of the machine tool, a simulation of the movement of the machine tool when the machine tool is operated based on the machining program so as to estimate the position of the tool; and a machining simulation unit (for example, a machining simulation unit 22 which will be described later) which performs a machining simulation of the machining target based on information of the tool and the position of the tool that is estimated.

(2) In the machining simulation device of the machine tool as described in (1), the machine simulation unit may determine the transfer characteristic of the machine tool based on the position command and at least one of the position feedback of a motor in the machine tool, the position feedback of the tool, the position feedback of the machining target and a servo parameter of a servo control unit which controls the motor based on the position command.

(3) The machining simulation device of the machine tool as described in (1) or (2) may further include a display unit (for example, a display unit 24 which will be described later) which displays the result of the machining simulation of the machining target by the machining simulation unit.

According to the present invention, it is possible to provide a machining simulation device of a machine tool which can highly accurately perform a machining simulation while reducing an increase in time.

### BRIEF DESCRIPTION OF THE DRAWINGS

FIG. 1 is a diagram showing a machining system which includes a machining simulation device of a machine tool according to the present embodiment;

FIG. 2 is a diagram showing a conventional machining system which includes a machining simulation device of a machine tool; and

FIG. 3 is a diagram showing a command route based on a position command and an actual route.

### DETAILED DESCRIPTION OF THE INVENTION

An example of an embodiment of the present invention will be described below with reference to accompanying drawings. In the drawings, the same or corresponding parts are identified with the same reference numerals.

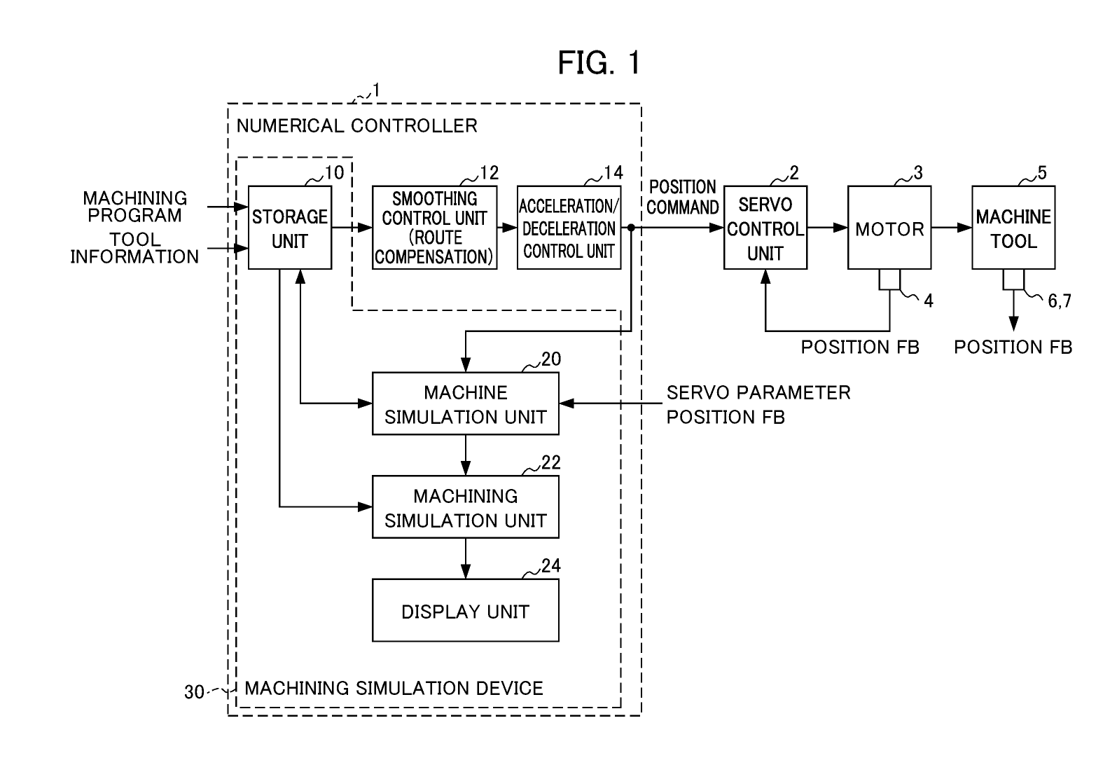

FIG. 1 is a diagram showing a machining system which includes a machining simulation device of a machine tool according to the present embodiment. The machining system shown in FIG. 1 includes a numerical controller 1 which includes the machining simulation device 30 (the details of which will be described later), a servo control unit 2, a motor 3 and the machine tool 5.

The machine tool 5 is, for example, a machine which uses a tool such as a ball end mill so as to perform machining on the surface of a workpiece (machining target). The machine tool 5 includes a position sensor 6 which detects the position of the tool, and the position of the tool detected with the position sensor 6 is utilized as position feedback (position FB). As the position sensor 6, a scale or the like which is provided for measuring the position of a tool tip portion can be used. The machine tool 5 may include a position sensor 7 which detects the position of the workpiece, and the position of the workpiece detected with the position sensor 7 may be utilized as position feedback (position FB). As the position sensor 7, a scale or the like that is provided in a table on which the workpiece is mounted can be used.

The motor 3 is provided in the machine tool 5. The motor 3 includes a motor which drives the movable part of the machine tool 5, for example, a tool feed axis or a workpiece feed axis. In the motor 3, an encoder 4 is provided which detects the rotation position (rotation angle) of the motor 3. The rotation position detected with the encoder 4 is utilized as position feedback (position FB). Here, since the rotation position of the motor 3 corresponds to the position of the movable part of the machine tool 5, the rotation position detected with the encoder 4, that is, the position feedback indicates the position of the tool or the position of the workpiece.

The servo control unit 2 calculates a drive current for the motor 3 based on a position command from the numerical controller 1 and the position feedback detected with the encoder 4 provided in the motor 3. The servo control unit 2 may use, instead of the position feedback detected with the encoder 4 provided in the motor 3, the position feedback detected with the position sensor 6 provided in the tool tip portion or may use the position feedback detected with the scale 7 provided in the table on which the workpiece is mounted.

The numerical controller 1 calculates the position command based on a machining program. The numerical controller 1 includes a storage unit 10, a smoothing control unit 12 and an acceleration/deceleration control unit 14.

The storage unit 10 stores the machining program which is produced in a CAM (Computer Aided Manufacturing). The storage unit 10 also stores tool information on, for example, the type of tool such as the ball end mill and a tool shape such as a tool diameter and a tool length. The storage unit 10 is, for example, a rewritable memory such as an EEPROM.

The smoothing control unit 12 performs smoothing control on a movement route based on a movement command indicated by the machining program stored in the storage unit 10. Specifically, the smoothing control unit 12 compensates for the movement command into a smooth route, and thereafter interpolates points on the movement route after the compensation at an interpolation period (route compensation).

The acceleration/deceleration control unit 14 calculates a movement speed pattern based on the movement command which is interpolated in the smoothing control unit 12, an acceleration/deceleration based on an acceleration/deceleration time constant and the maximum speed, so as to calculate the position command based on the movement speed pattern.

The numerical controller 1 includes a machine simulation unit 20, a machining simulation unit 22 and a display unit 24. The machine simulation unit 20, the machining simulation unit 22, the display unit 24 and the storage unit 10 described above configure the machining simulation device 30 of the present embodiment. Although in the present embodiment, a form in which the machining simulation device 30 is incorporated in the numerical controller 1 is illustrated, the form in which the machining simulation device 30 is incorporated is not limited to this form. For example, the machining simulation device 30 may be incorporated in an external PC or the like. The individual constituent elements (the machine simulation unit 20, the machining simulation unit 22, the display unit 24 and the storage unit 10) of the machining simulation device 30 may be separately incorporated in a plurality of devices. For example, the machine simulation unit 20, the display unit 24 and the storage unit 10 may be incorporated in the numerical controller, and the machining simulation unit 22 may be incorporated in the external PC (for example, a CAD-CAM).

The machine simulation unit 20 determines a response characteristic for the position command as a transfer characteristic. Specifically, the machine simulation unit 20 determines, as the transfer characteristic of the machine tool (for example, a transfer function), a transfer characteristic in stages subsequent to the numerical controller 1, that is, a transfer characteristic from the servo control unit 2 to the machine tool 5. The machine simulation unit 20 stores, in the storage unit 10, the transfer characteristic of the machine tool which is determined. The machine simulation unit 20 performs an operation of determining the transfer characteristic of the machine tool, for example, only once before a machining simulation is performed by the machining simulation unit 22. Then, when the machining simulation is performed by the machining simulation unit 22, the machine simulation unit 20 performs, based on the position command and the transfer characteristic of the machine tool stored in the storage unit 10, the simulation of the movement of the machine tool when the machine tool is operated based on the machining program, and thereby estimates the position of the tool, that is, the route (path) of the tool.

When the transfer characteristic of the machine tool is determined, the machine simulation unit 20 determines the transfer characteristic of the machine tool based on the position command and at least one of a servo parameter for the servo control unit 2, the position feedback of the motor 3, the position feedback of the tool and the position feedback of the workpiece. As the servo parameter, a position gain or a speed gain of the servo control unit 2 or the like can be mentioned. As the position feedback of the motor 3, the rotation position (position feedback) of the motor 3 detected with the encoder 4 provided in the motor 3 is mentioned. As the position feedback of the tool, the position (position feedback) of the tool detected with the position sensor 6 provided in the tool tip portion is mentioned. As the position feedback of the workpiece, the position (position feedback) of the workpiece detected with the position sensor 7 provided in the table on which the workpiece is mounted is mentioned.

When the transfer characteristic of the machine tool is determined based on the servo parameter of the servo control unit 2, the machine simulation unit 20 can determine it without actually operating the machine tool. In this way, the machine simulation unit 20 can estimate position information of the tool based on the position command and the transfer characteristic without actually operating the machine tool. When the transfer characteristic of the machine tool is determined based on the position feedback of the motor 3, the position feedback of the tool or the position feedback of the workpiece, the machine simulation unit 20 can determine it by operating the machine tool only once. In this way, in the second and subsequent operations, the machine simulation unit 20 can estimate the position of the tool based on the position command and the transfer characteristic without actually operating the machine tool.

The machining simulation unit 22 performs the machining simulation of the workpiece based on the information (for example, the information on the type of tool such as the ball end mill and the tool shape such as the tool diameter and the tool length) of the tool stored in the storage unit 10 and the position of the tool estimated in the machine simulation unit 20.

The display unit 24 displays the result of the machining simulation of the workpiece by the machining simulation unit 22. For example, the display unit 24 displays, as an image, the shape of the workpiece after the machining, the roughness of the machined surface of the workpiece after the machining or the like. In this way, it is possible to easily estimate a defect such as a scratch which occurs in the machined surface of the workpiece after the machining. The display unit 24 is a display device such as a liquid crystal display.

The numerical controller 1, the machining simulation device 30 (other than the storage unit 10 and the display unit 24) and the servo control unit 2 are formed with, for example, a computation processor such as a DSP (Digital Signal Processor) or an FPGA (Field-Programmable Gate Array). The individual types of functions of the numerical controller 1, the machining simulation device 30 and the servo control unit 2 are realized by executing, for example, predetermined software (programs) stored in a storage unit. The individual types of functions of the numerical controller 1, the machining simulation device 30 and the servo control unit 2 may be realized by cooperation of hardware and software or may be realized only by hardware (electronic circuit).

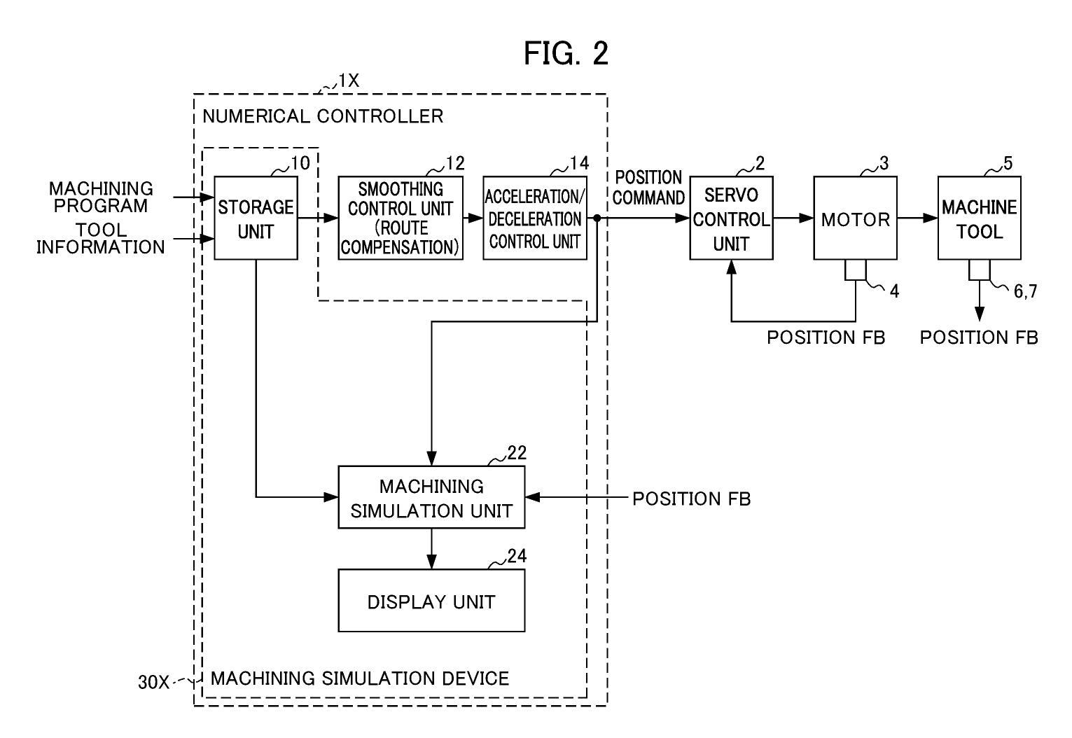

FIG. 2 is a diagram showing a conventional machining system which includes a numerical controller of a machine tool. The conventional machining system shown in FIG. 2 differs from the present embodiment in that in the machining system shown in FIG. 1, instead of the numerical controller 1, a numerical controller 1X is included. The numerical controller 1X differs from the present embodiment in that in the numerical controller 1 shown in FIG. 1, instead of the machining simulation device 30, a machining simulation device 30X is included. The machining simulation device 30X differs from the present embodiment in that in the machining simulation device 30 shown in FIG. 1, the machine simulation unit 20 is not included. In the machining simulation device 30X, the machining simulation unit 22 performs the machining simulation of the workpiece instead of the position of the tool estimated in the machine simulation unit 20 by use of the position feedback detected with the encoder 4 provided in the motor 3, the position feedback detected with the position sensor 6 provided in the tool tip portion or the position feedback detected with the scale 7 provided in the table on which the workpiece is mounted.

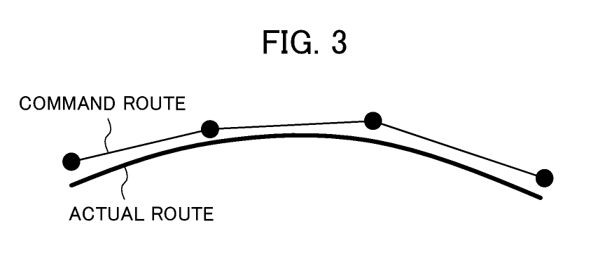

Here, in actual machining, as shown in FIG. 3, an actual route is often displaced from a command route based on the position command such that the machining cannot be performed according to the machining program. Hence, in the machining simulation based on only the machining program, for example, it is difficult to accurately evaluate the accuracy of the machined surface or the quality of the machined surface. By contrast, in the machining simulation device 30X, as in the technology disclosed in patent document 1 described previously, an actual position (feedback) detected with an actual sensor is further used such that the machining simulation is performed, and thus it is possible to accurately evaluate the accuracy of the machined surface or the quality of the machined surface. However, when as in the machining simulation device 30X, the actual position (feedback) detected with the actual sensor is used such that the machining simulation is performed, each time the machining simulation is performed, it is necessary to actually operate the machine tool, with the result that it takes time to do so.

In this regard, in the machining simulation device 30 of the machine tool according to the present embodiment, the machine simulation unit 20 performs, based on the position command and the transfer characteristic of the machine tool, the simulation of the movement of the machine tool when the machine tool is operated based on the machining program, and thereby estimates the position (route, path) of the tool whereas the machining simulation unit 22 performs the machining simulation of the workpiece based on the information of the tool and the position of the tool which is estimated. As described above, by use of the estimated position (route, path) of the tool with consideration given to the transfer characteristic of the machine tool, the machining simulation close to the actual machining is performed, and thus it is possible to accurately evaluate the accuracy of the machined surface or the quality of the machined surface. Since the machining simulation unit 22 does not use the position feedback of the motor 3, the position feedback of the tool and the position feedback of the workpiece, that is, it is not necessary to actually operate the machine tool, it is possible to reduce an increase in time which is needed for the machining simulation of the workpiece. When the position (route, path) of the tool is estimated by the machine simulation unit 20, as described above, the machine tool is not actually operated or the machine tool is operated only once in the first place even if the machine tool is actually operated. Hence, in the machining simulation device 30 of the machine tool according to the present embodiment, it is possible to highly accurately perform the machining simulation while reducing an increase in time.

In the machining simulation device 30 of the machine tool according to the present embodiment, the display unit 24 displays the result of the machining simulation of the workpiece by the machining simulation unit 22. In this way, when the machined surface is checked before the actual machining is performed, and the machined surface is clearly different from a machined surface which is expected, a parameter or the like for the numerical controller is immediately adjusted, and the result of the adjustment is visualized, with the result that the machined surface can be improved. It is also possible to identify the cause of a failure such as a scratch which occurs in the machined surface.

Although the embodiment of the present invention is described above, the present invention is not limited to the embodiment described above, and various modifications and variations are possible. For example, although in the embodiment described above, the machining simulation device of the machine tool which performs machining is illustrated, the feature of the present invention is not limited to this application, and can be applied to the machining simulation devices of machine tools which perform various types of machining such as grinding and polishing.

### EXPLANATION OF REFERENCE NUMERALS

1, 1X numerical controller
2 servo control unit
3 motor
4 encoder
5 machine tool
6, 7 position sensor
10 storage unit
12 smoothing control unit
14 acceleration/deceleration control unit
20 machine simulation unit
22 machining simulation unit
24 display unit
30 machining simulation device

What is claimed is:

1. A machining simulation device of a machine tool which performs a machining simulation of the machine tool that machines a machining target based on a machining program with a tool, the machining simulation device comprising:
a machine simulation unit which performs, based on a position command and a transfer characteristic of the machine tool, a simulation of a movement of the machine tool when the machine tool is operated based on the machining program so as to estimate a position of the tool; and
a machining simulation unit which performs a machining simulation of the machining target based on information of the tool and the position of the tool that is estimated.

2. The machining simulation device of the machine tool according to claim 1, wherein the machine simulation unit determines the transfer characteristic of the machine tool based on the position command and at least one of position feedback of a motor in the machine tool, position feedback of the tool, position feedback of the machining target and a servo parameter of a servo control unit which controls the motor based on the position command.

3. The machining simulation device of the machine tool according to claim 1, the machining simulation device further comprising a display unit which displays a result of the machining simulation of the machining target by the machining simulation unit.
